(19) United States
(12) Patent Application Publication
(10) Pub. No.: US 2022/0058604 A1
(43) Pub. Date: Feb. 24, 2022

(54) Autonomous Food Station

(71) Applicants: Dov Z. Glucksman, Winchester, MA (US); Andrew Joseph Rojee, Derry, NH (US); Michael David Miller, Tewksbury, MA (US); Kent Yu, Pacific Palisades, CA (US)

(72) Inventors: Dov Z. Glucksman, Winchester, MA (US); Andrew Joseph Rojee, Derry, NH (US); Michael David Miller, Tewksbury, MA (US); Kent Yu, Pacific Palisades, CA (US)

(21) Appl. No.: 17/387,936

(22) Filed: Jul. 28, 2021

Related U.S. Application Data
(60) Provisional application No. 63/066,904, filed on Aug. 18, 2020.
(60) Provisional application No. 63/105,056, filed on Oct. 23, 2020.

(51) Int. Cl. G06Q 20/18; G06Q 50/12

(52) U.S. Cl. CPC G06Q 20/18; G06Q 50/12

(57) ABSTRACT

A system including software and hardware and a smartphone application for enabling consumers to order and pay for a consumable from an extensive menu of hot and cold choices, and from one or more consumable providers, then to receive the chosen consumable in a fresh and properly temperatured state at a pre-chosen time.

### FIELD OF THE INVENTION

This invention relates to the food service industry. More particularly, the invention relates to means for providing pre-ordered hot and cold foods to users in a vending system.

### BACKGROUND

Vending machines which provide cold sandwiches and snacks are well known. The machines are regularly stocked with a selection of items, each indicating an item price, and customers may insert payment and select one of the provided items for consumption at the stored temperature or for heating remotely. Such machines offer a limited number of items chosen by a food partner in some remote location, which may or may not be the type of food truly desired by the customer, forcing the customer to choose the “least undesirable” item.

There is a need for, and it is an object of the invention to provide, an autonomous food storing and delivering system for enabling consumers to remotely pre-order a desired food, snack, or entire meal from an extensive menu of hot or cold choices, then to receive the chosen food, snack, or meal at a conveniently nearby location in a fresh and optimally temperatured state at a pre-chosen time or at an amendable time.

Additional needs and means to satisfy those will be learned, become apparent, or become obvious upon review of the disclosure provided herein.

### SUMMARY OF THE INVENTION

The invention may be embodied in or practiced using an autonomous system including software and hardware for enabling consumers to order and pay for a desired food, snack, or meal from an extensive menu of hot or cold choices, and from one or more food, snack, or meal providers, then to receive the chosen food, snack, or meal in a fresh and optimally temperatured state at a pre-chosen future time.

A novel and non-obvious aspect of the system may reside in its ability to enable consumers to receive the ordered and paid for food, snack, or meal at a convenient location at the pre-chosen time.

Another novel and non-obvious aspect of the system may be having delivery Stations (autonomous vending apparatuses) conveniently placed where the consumers may receive the chosen food, snack, or meal.

Another novel and non-obvious aspect of the system may reside in providing a convenient means for enabling a consumer to choose, pay for, and order a consumable for receipt at a later time and to receive a security key, such as a code, for identification and access at the Station.

Another novel and non-obvious aspect of the system may reside in delivering the consumable in a ready-to-consume condition at or around that later time.

Another novel and non-obvious aspect of the system may reside in providing the consumable in sealed portion container.

Another novel and non-obvious aspect of the system may reside in its ability to enable one or more food partners (consumable providers) to deposit the pre-ordered consumables into a chamber within the apparatus which is adapted to store the consumable at a temperature capable of maintaining the freshness of the consumable until an appropriate time before the later time, to begin warming or cooling the consumable at that appropriate time so that it will be ready to consume at the later time, and for moving the consumable to a delivery port at the demand of the identified consumer at or after the later time.

Another novel and non-obvious aspect of the system may reside in providing a convenient means for enabling a consumer to reschedule the later time at any reasonable time prior to the appropriate time.

Another novel and non-obvious aspect of the vending system may reside in using the security key for allowing only the consumer to reschedule the later time.

Another novel and non-obvious aspect of the system may reside in its ability for receiving the consumable from the consumable provider, moving it into its storage chamber, maintaining the storage temperature in the chamber, recognizing the appropriate time, providing the warming or cooling in the chamber, recognizing the later time, recognizing the key when provided by the consumer, transporting the consumable to the delivery port, and allowing access to the consumable by the consumer.

Another novel and non-obvious aspect of the system may reside in its labor-saving advantage based on the ability for receiving the consumable from the consumable provider, delivering it, in bulk, to the apparatus, randomly placing the consumable containers into an empty storage chamber, recognizing the content of the consumable container for providing the appropriate warming or cooling in the chamber, for recognizing the later time, for recognizing the key when provided by the consumer, for transporting the consumable to the delivery port.

Another novel and non-obvious aspect of the system may reside in the small amount of wall space the unit occupies as the consumer does not have to access the consumable storage directly but that the consumable is delivered to the Consumer through a hatch, located at a height determined to be most convenient for the average Consumer

Additional novel and non-obvious aspect of the system and the apparatus will be learned, become apparent, or become obvious upon review of the disclosure provided herein.

### BRIEF DESCRIPTION OF THE DRAWINGS

Exemplary embodiments of an autonomous food station in accordance with or useful in practicing the invention are shown in the accompanying Drawings, of which;

FIG. 1 is a flow chart of the ecosystem of a first autonomous food station;

FIG. 2 is a cross-sectional view of the portion containers of the station of FIG. 1;

FIG. 3 is a schematic diagram of the generation and circulation of the cooling and heating fluids of the station of FIG. 1;

FIG. 4 is a cross-sectional view circulation of the cooling and heating fluids to the individual cubbies of the station of FIG. 1;

FIG. 5 is a perspective view of the transport system of the station of FIG. 1;

FIG. 6 is a perspective view of the cartesian system of the station of FIG. 1;

FIG. 7 is a cross-sectional view of the hatch of the station of FIG. 1;

FIG. 8 is a perspective view of the hatch of the station of FIG. 1;

FIGS. 9A through 9L is a series of chronologically-arranged perspective views showing the movement of the portion container and portion container carrier of the station of FIG. 1;

FIG. 10 is a front view of the station of FIG. 1;

FIG. 11 is a side cross-sectional view of the station of FIG. 1;

FIG. 12 is a left perspective view of the station of FIG. 1 with its left cubby access panel opened;

FIG. 13 is a right perspective view of the station of FIG. 1 with its right cubby access panel opened;

FIG. 14 is a front perspective view of the unit base compartment of the station of FIG. 1;

FIG. 15 is a rear perspective view of the unit base compartment of the station of FIG. 1;

FIG. 16 is a cross-sectional view of the portion container of the station of FIG. 1;

FIG. 17 is a cross-sectional view of a cubby of the station of FIG. 1;

FIG. 18 is a top view of a cubby of the station of FIG. 1;

FIG. 19 is an exploded view of the heating and cooling terminals of a cubby of the station of FIG. 1;

FIG. 20 is a perspective cross-sectional view of a cubby of the station of FIG. 1;

FIG. 21A is an exploded view of a cubby of the station of FIG. 1;

FIG. 21B is a perspective view of the portion container carrier of the station of FIG. 1;

FIG. 22 is a left perspective view of a second autonomous food station;

FIG. 23 is a right perspective view of the station of FIG. 25 with its left cubby access panel opened; and

FIG. 24 is a cross-sectional view of the station of FIG. 25.

### DETAILED DESCRIPTION OF AN EXEMPLARY EMBODIMENT

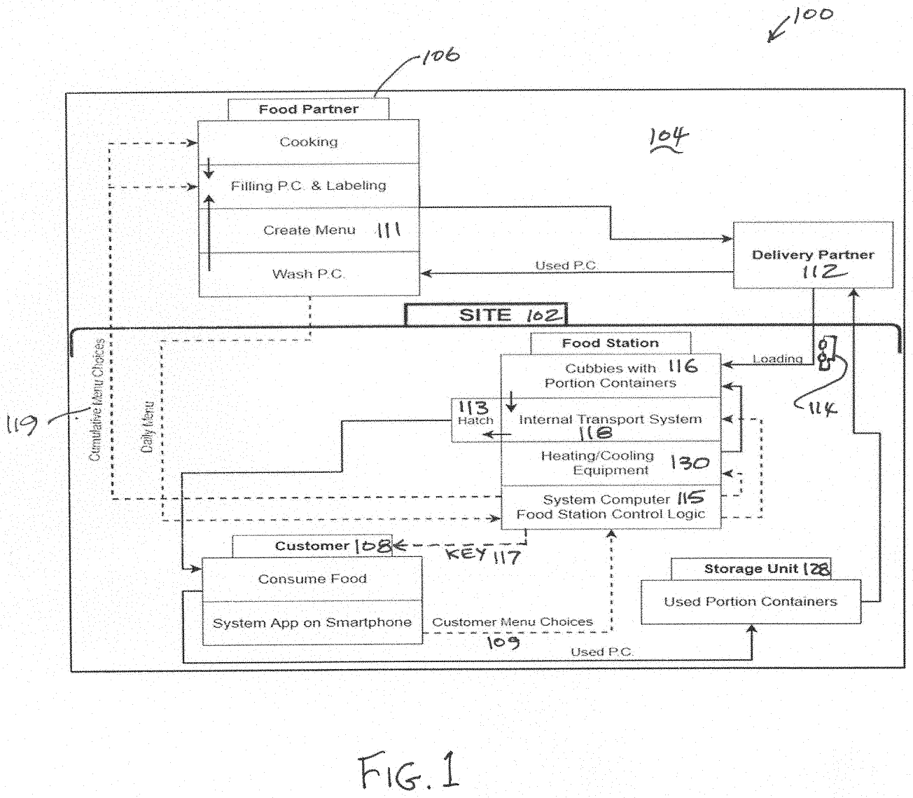

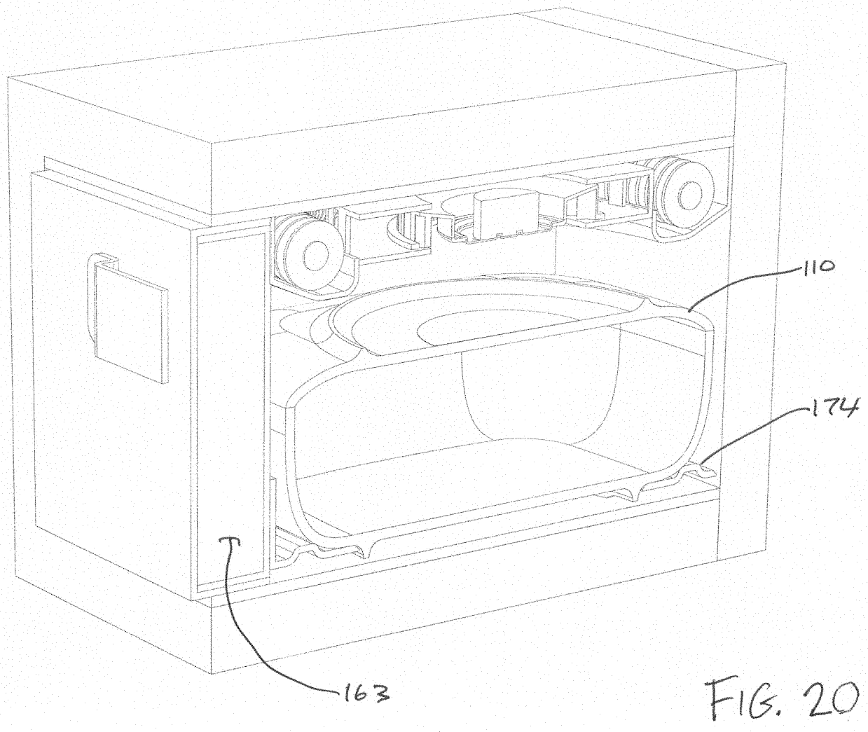

Referring to FIGS. 1 through 21B, there is shown a system 100 based around a first autonomous Food Station 102. Numerous of such Stations may be conveniently positioned around a neighborhood, town, or city and may be owned/operated by the same entity/entities or may be owned by different entities.

An exemplary flow chart of operation 104 of the system for one of the Stations is shown in FIG. 1 and described as follows to demonstrate the system and process.

A remote Food Partner (food provider) 106 may own the Station or be hired by the Station's owner to prepare and supply meals for the Station. More than one food provider may prepare and supply meals to any given Station or Stations, so that consumers may have the option to purchase meals of numerous types. The food providers may be well known restaurants whose brand more readily attracts consumers, or the food provider may be commissaries. The owner may place numerous Stations around town or may be a franchisee who buys one or more Station(s) from a franchiser who may in turn control and partially profit from the meals provided. For instance, a popular restaurant chain may sell franchises and each Station's franchisee may be given a larger menu which is limited to meals from that restaurant and may be required to make their smaller menu choice from that larger menu. The food provider might then profit from the sale of the meal to the Station owner and the Station owner may profit from the sale of the meal to the end customer. Or the Station owner may be one and the same as the food provider and thereby obtain all profits. Or the Station owner may pay a location owner a rental fee or a share of the profits for being allowed to place the Station(s) in one or more convenient location(s) owned by the location owner.

The Station Owner may place the Stations in select locations such as apartment building lobbies, office buildings, office lunchrooms, workplace lobbies, university cafeterias, hospital cafeterias, taverns, etc., . . . typically anyplace that is convenient to consumers who are in the same vicinity day after day.

Either the food provider or the Station Owner may always offer the same menu or may generate a weekly menu with a range of meal choices (a steak dinner, soup and sandwich, burger and fries, etc.), or with a range of meal components (proteins, sides, vegetables, etc.), or a range of ethnicities (Italian, Chinese, Mexican, etc.), and with a range of desserts (hot apple pie, cold desserts, room temperature pastries, etc.).

A Customer (the ultimate consumer) 108 then selects a meal from a list of Cumulative Menu Choices 111 offered by the food provider and orders the selected consumable in advance using a system program, which may be a Smartphone App, may be a call-in phone number, may be an on-line site, or may be a user-interface on the Station. The consumer reviews the menu and places a Customer Menu Choice 109 say a day in advance of the desired receipt of the meal (Day 0). This order is stored in Food Station Control Logic 115 and the consumer is provided with an Identification Key 117. Cumulative Customer Menu Choices 119 are transmitted to the Food Partner who then prepares the meal and places it into a Portion Container 110. Each Portion Container is provided with an identifying label that can be read and the data stored in the Food Station Control Logic.

On the morning of Day 0, the Portion Containers are picked up from the food provider and delivered to the Station by a Delivery Partner 112, or may be delivered by the food provider, preferably in a Refrigerated Transport Unit 114. The containers are randomly loaded into individual Cubbies 116 in the Food Station.

After all Portion Containers are loaded into their Cubbies, an Internal Transport System 118 transports each Portion Container to an Identifier Station 122 to have its Identifying Label 124 scanned and then be returned to its Cubby. Food Station Control Logic links the identified meal with the associated identification key and its Cubby. Each meal may have a meal preparation instruction specific thereto. This instruction may be stored in the logic's memory or may be provided to the logic by a code on the Identifying Label. For instance, a soup may be best served at 160 F while a grilled cheese sandwich may be best served at 130 F, and a tuna sandwich may be best served at room temperature. This preparation instruction would also be linked to the Cubby.

The information on the Identifying Label, the Cubby number, the identification key, and the preparation instruction for each loaded Cubby are stored in the Food Station Control Logic. After the Identifying Labels have been read, the Food Station Control Logic commands the system to refrigerate all the Cubbies containing Portion Containers, and to maintain them at say 37 F, being considered a temperature suitable for extended safe storage of cooked food, and a temperature where the taste and flavor of the food is not affected within the typical time the consumable is kept in the Station.

Assuming a specific Portion Container holds a meal to be delivered warm or hot, then one hour or so before the schedule (or an amended) pick-up time, the Food Station Control Logic will command heating of the Cubby and its Portion Container containing the food to be served to a temperature of say 140 F, or some other appropriate temperature, and keep it at that temperature until it is ready to be picked up. If the food is to be served cold, it may be maintained at the refrigerated temperature. If the food is to be served at room temperature, it may be warmed only to room temperature.

Customers coming to pick up their food will first identify themselves to the Food Station Control Logic using their identification key. The Food Station Controller then directs the Internal Transport System to pick up the appropriate Portion Containers and to deliver them to a Collection Hatch 113. The Food Station Control Logic will stop the heating or cooling of Cubbies that no longer contain Portion Containers.

After Customers consumed their meals, they may bring the empty Portion Containers and place them in the Storage Unit 128, where they are kept in a moist and warm atmosphere until the Delivery Partner picks them up the following morning to deliver them to the Food Partner, to be washed and sterilized for re-use. The Storage Unit may be a large container external of the Station intended merely to collect the spent Portion Containers or may be an internal function and portion of the Station. If internal, the Storage Unit may have means to move, scan, and identify the returned Portion Container and the Customer may then receive a return deposit or credit against his account.

In the event that the Portion Containers are disposable, compostable or recyclable the Portion Containers may be identified by the appropriate disposal icons or terms for the Customer to be guided by.

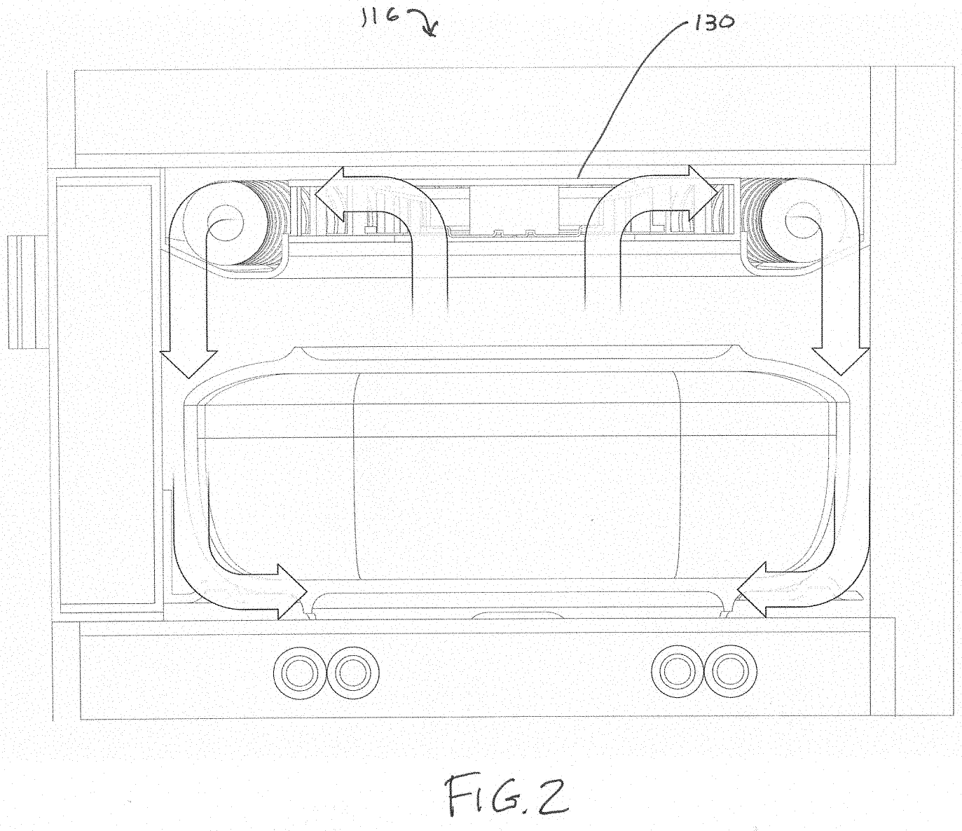

A typical Portion Container within a typical Cubby is shown in FIG. 2. Each Portion Container is cooled and heated independently of the other Portion Containers, each held in an independent Cubby with its own independent cooling and heating terminal. Also shown is the Cubby's Cooling and Heating Terminal 130.

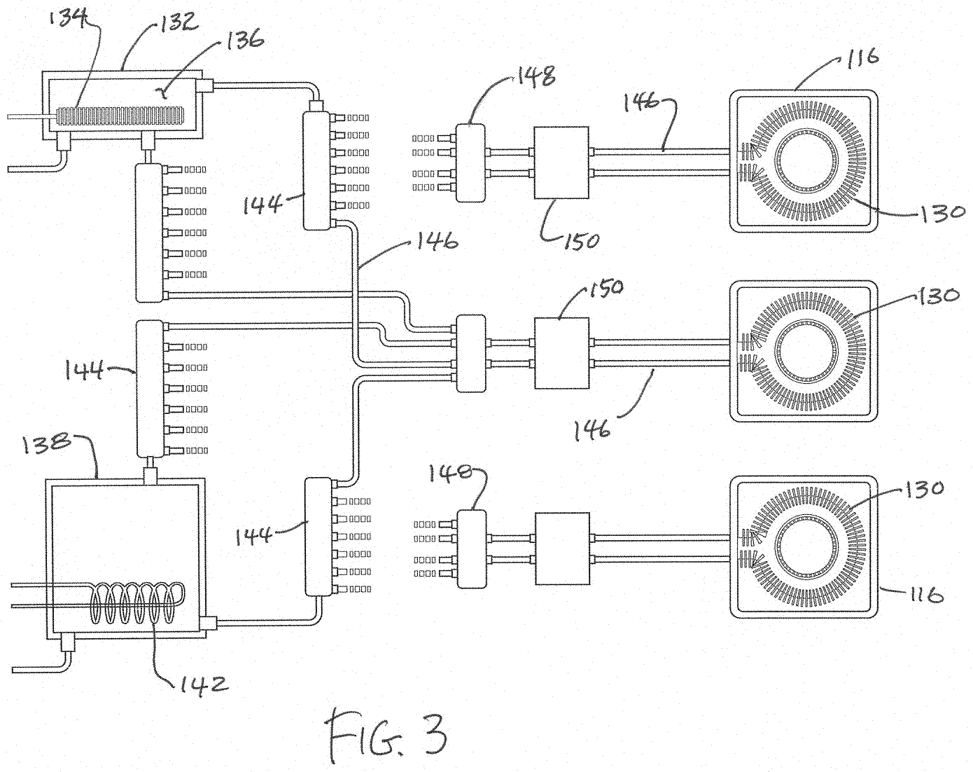

A schematic representation of the system cooling and heating arrangement is shown in FIG. 3. It includes a conventional 4000 BTU refrigeration system 132 with a shell and tube evaporator 134 for cooling a thermal fluid 136, and a conventional boiler 138 including a submersed electric heating element 142. The system also includes headers 144 for connecting to a series of circulation tubes 146, valves 148, and individual pumps 150 for driving the fluids through the Cooling and Heating terminals. While FIG. 3 shows individual pumps, such pumps may be replaced by one pump and a multitude of valves, serving to supply heated or chilled thermal fluid to the cooling and heating terminals.

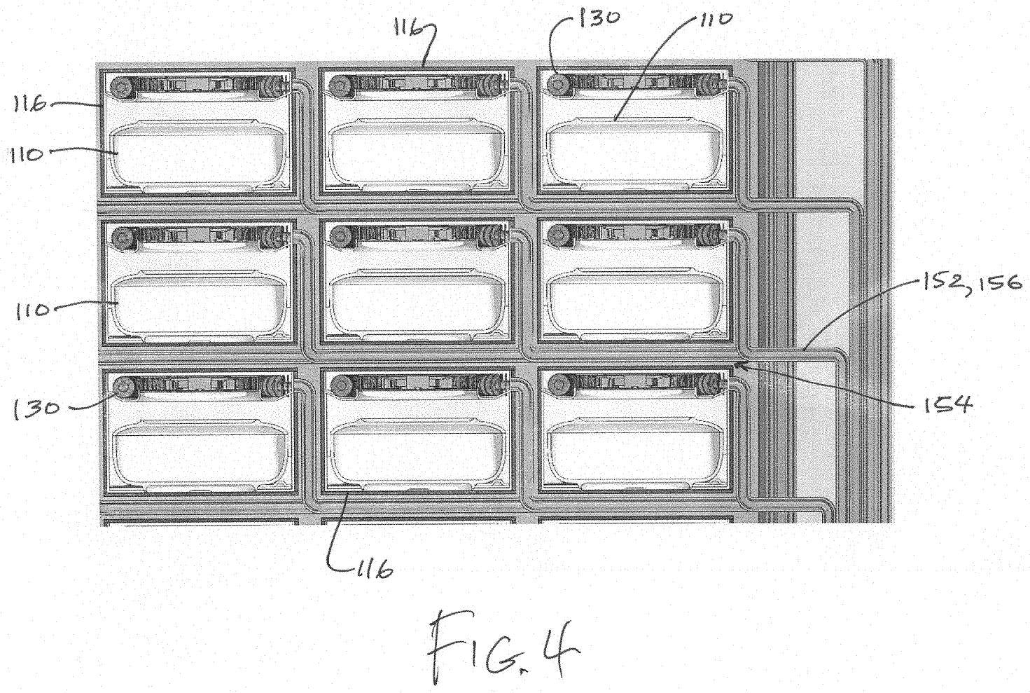

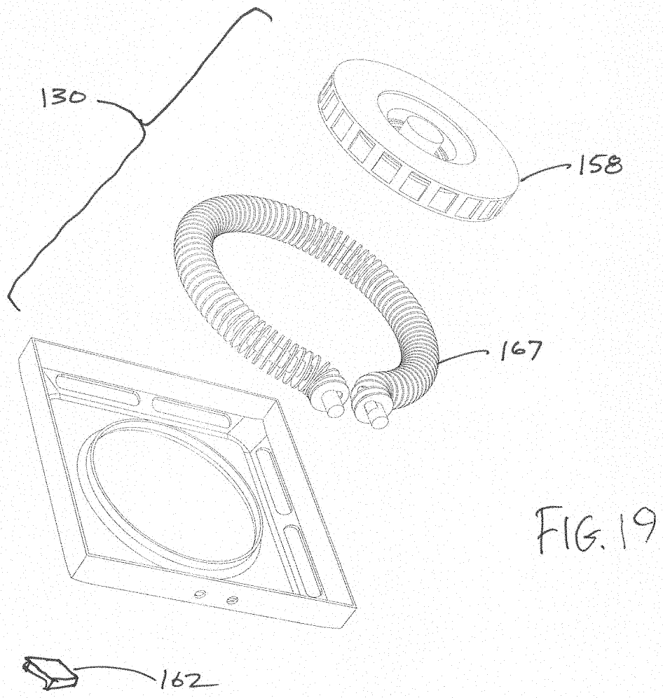

The Cubby cooling and heating arrangement is shown in FIGS. 4 and 19. Flexible insulated tubes 152 are channeled through a 25 mm gap 154 between the Cubbies. 12 mm diameter tubes are used as well as low-voltage insulated electric wires 156 connected to Cubby fans 158 and NTC temperature sensors 162. A preferred assembly sequence is to lay the tubes and wires into the gaps between the Cubbies, connect their ends as needed, and blow-in expandable polyurethane insulation after the tubes and electric wires have been tested and found to operate satisfactorily.

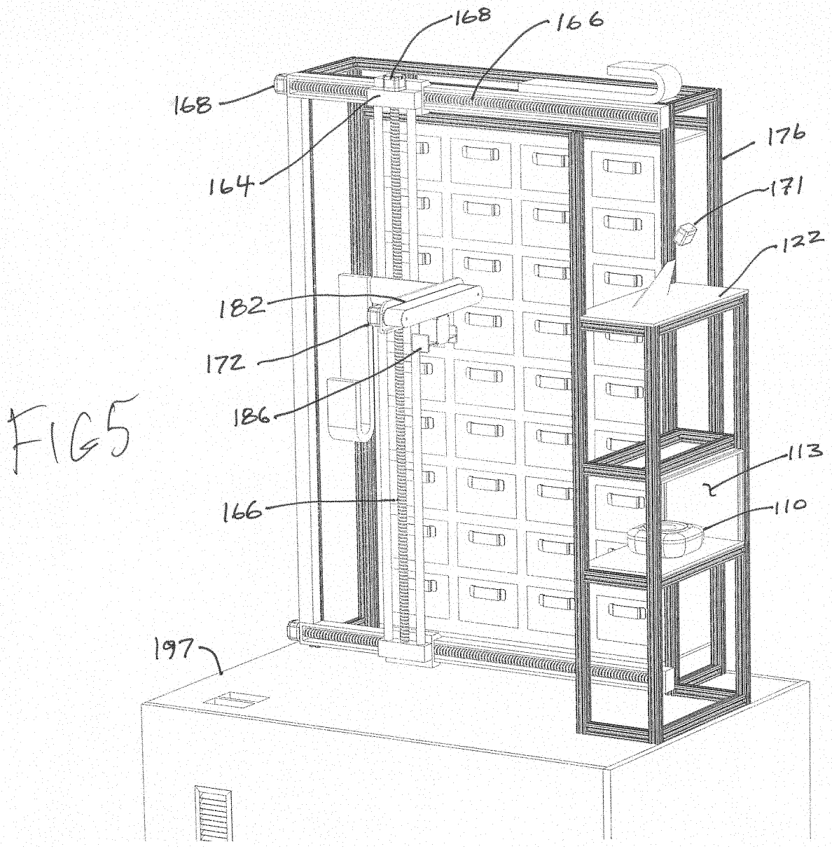

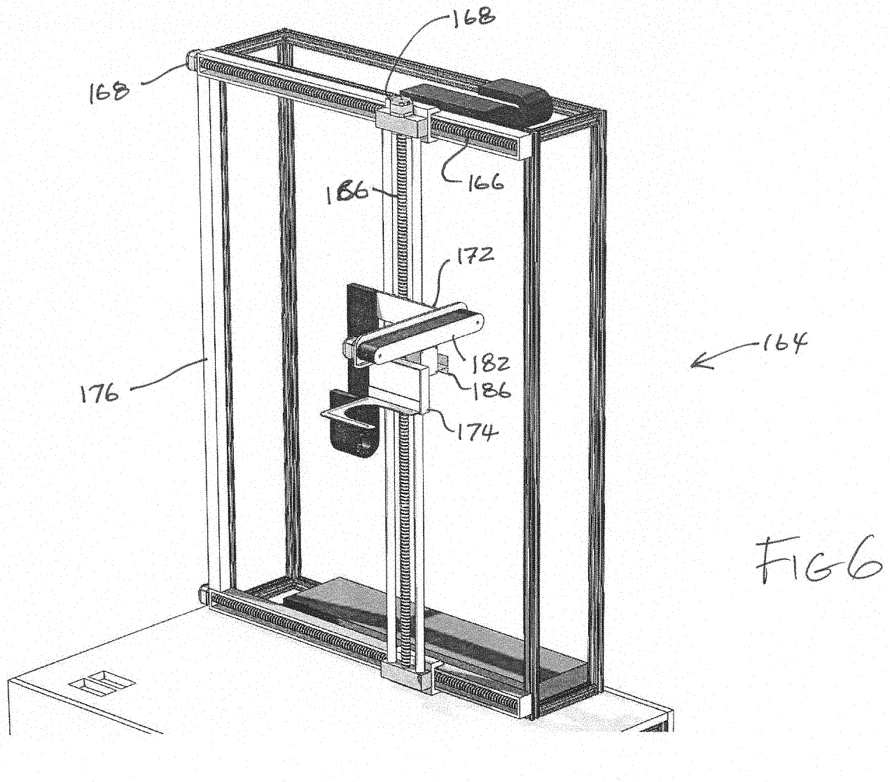

As seen in FIGS. 5 and 6, a Cartesian transport system 164 is employed to move the Portion Containers within the Station. The system operates along X, Y, and Z axes to transport the containers, comprising drive spindles 166 and stepper motors 168, as well as an End-Effector 172 adapted to pick up Portion Container Carriers 174 which are located to either side of the transport system.

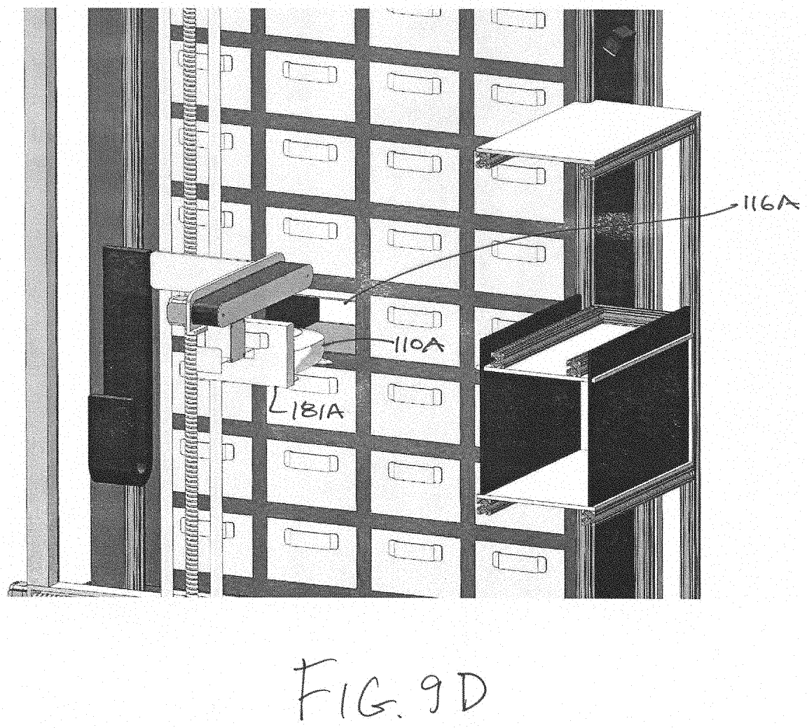

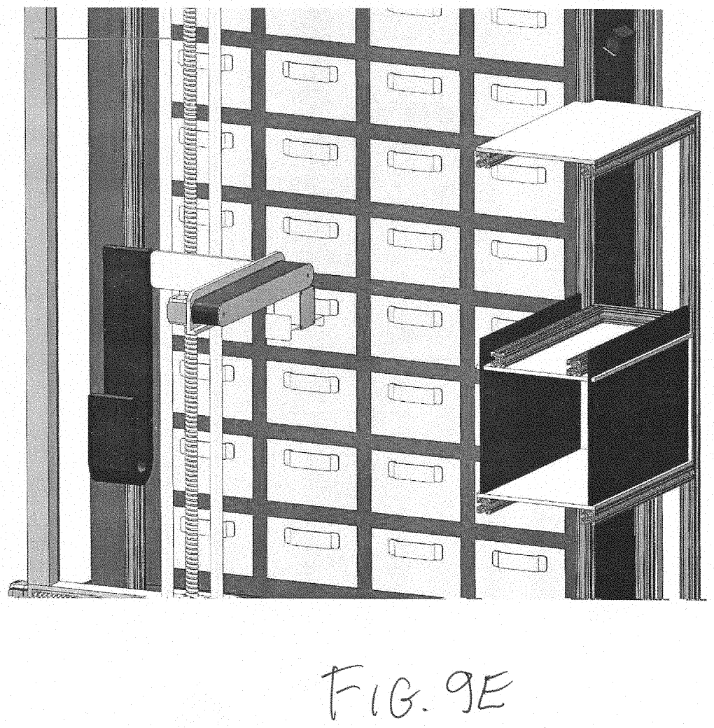

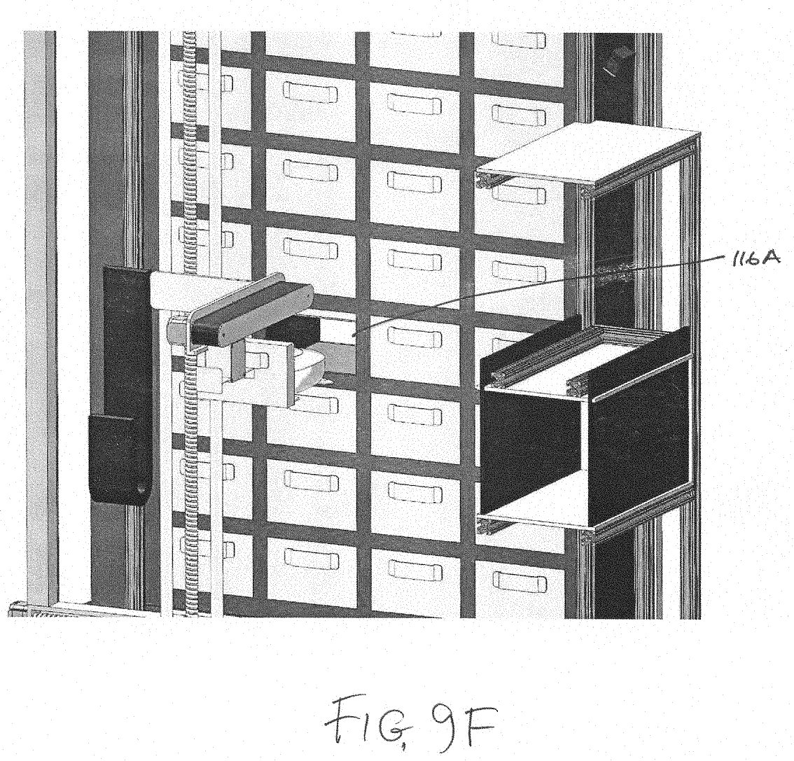

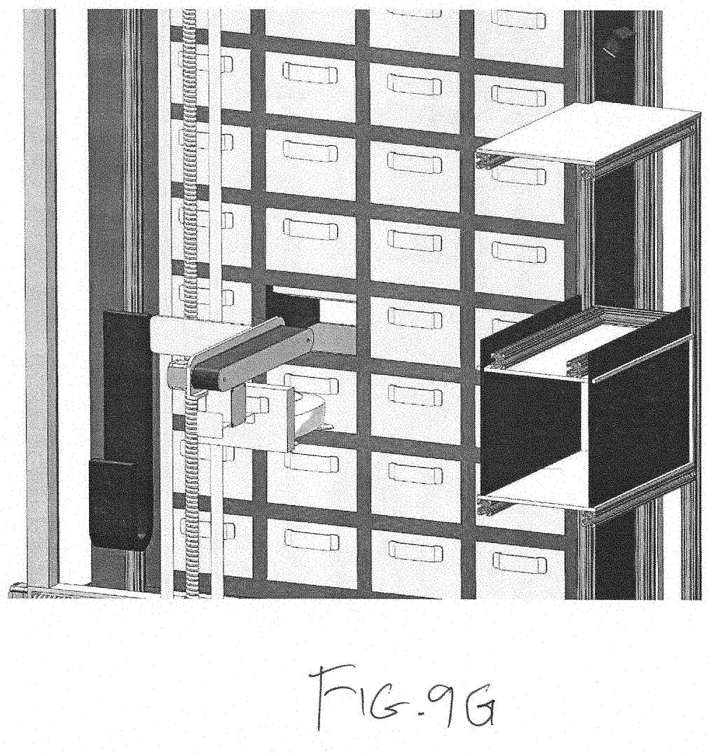

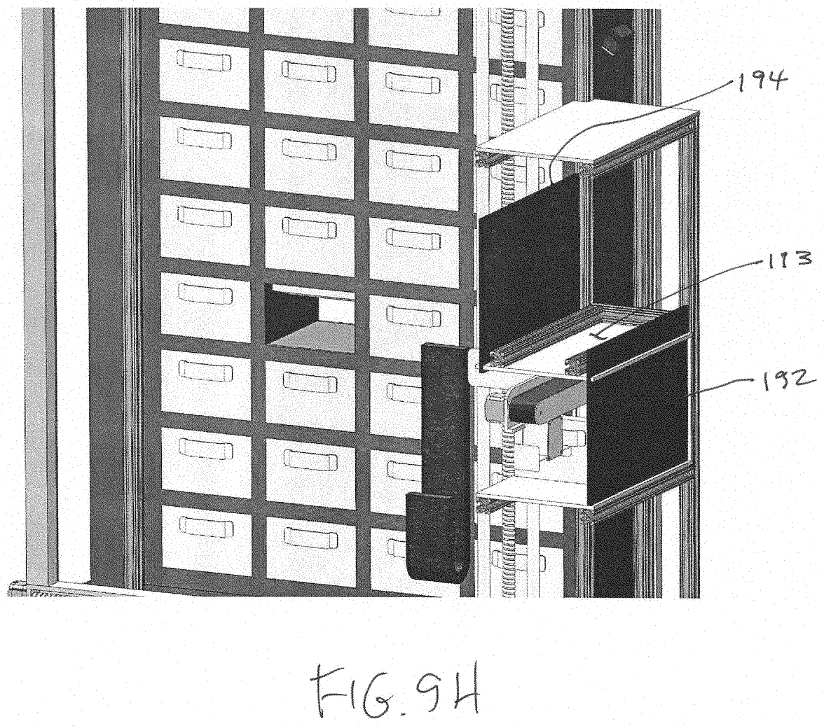

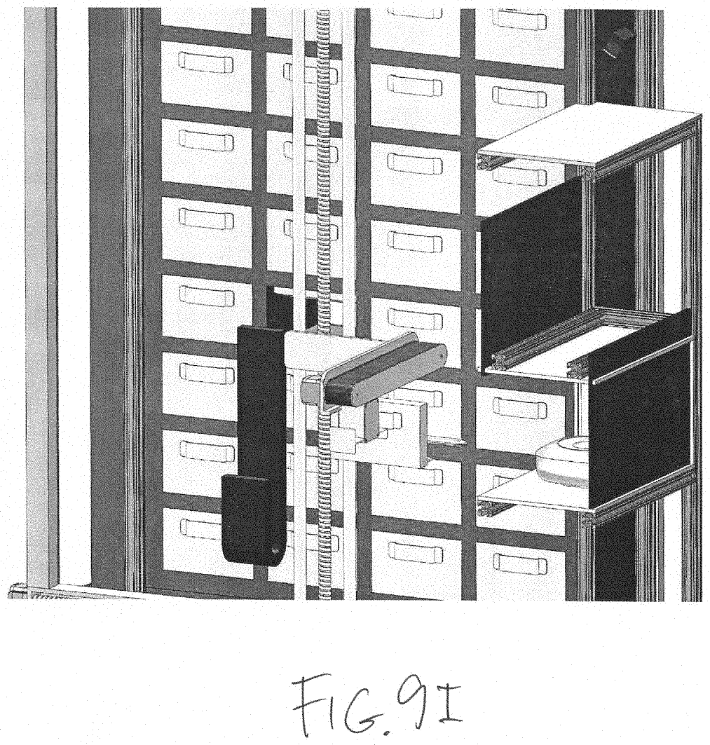

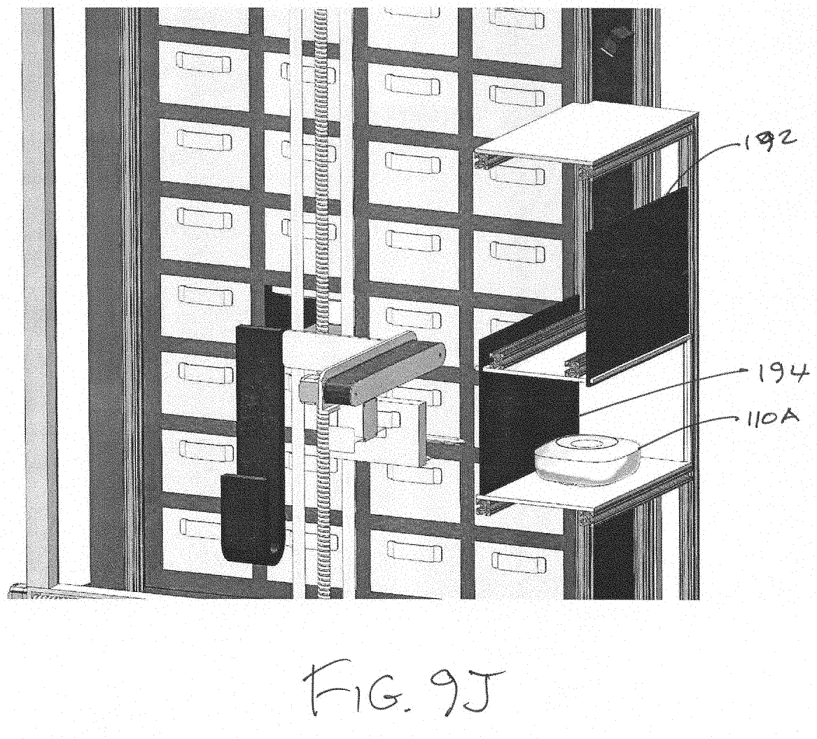

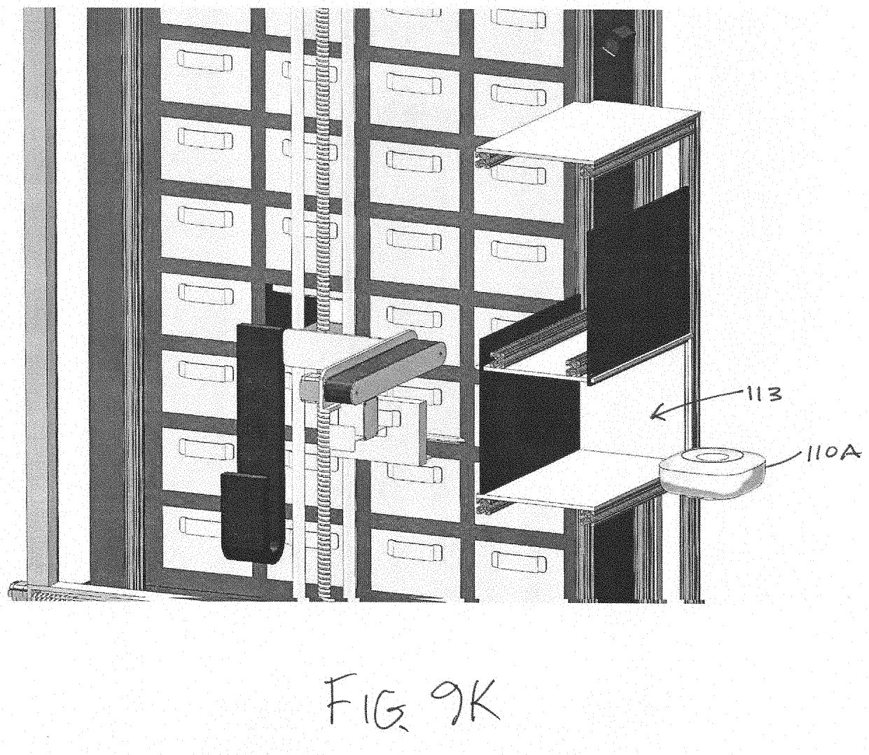

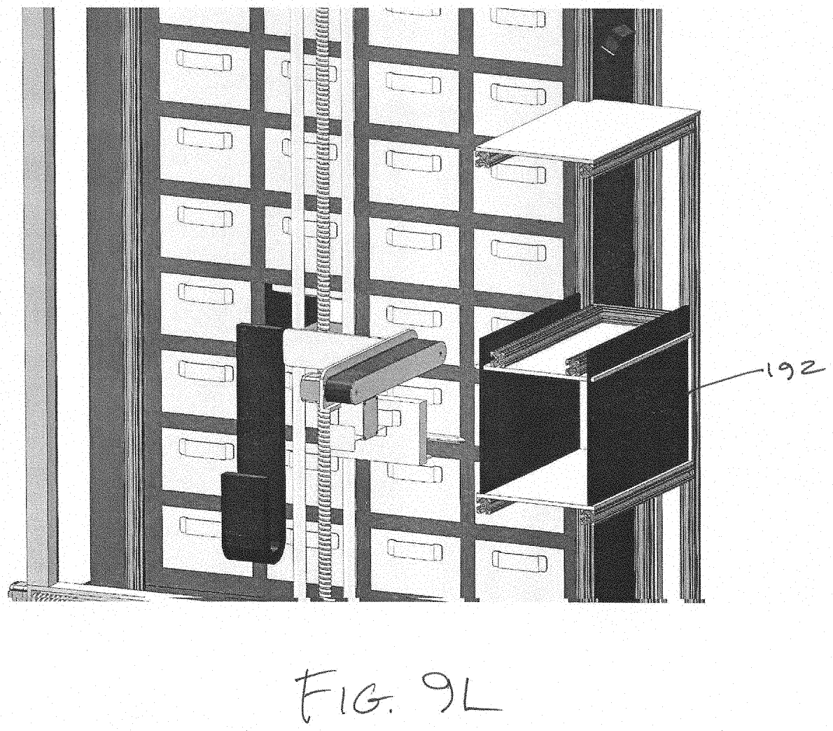

Referring to FIG. 9A, the X axis is horizontal and runs side-to-side relative to the Station, the Y axis is vertical, and the Z axis is horizontal and runs front-to-back relative to the Station.

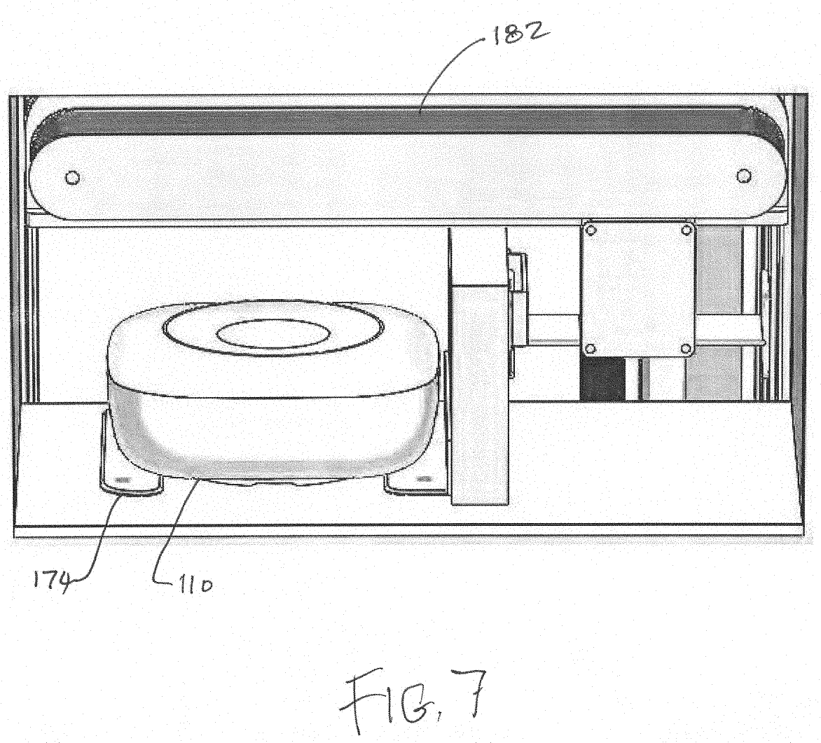

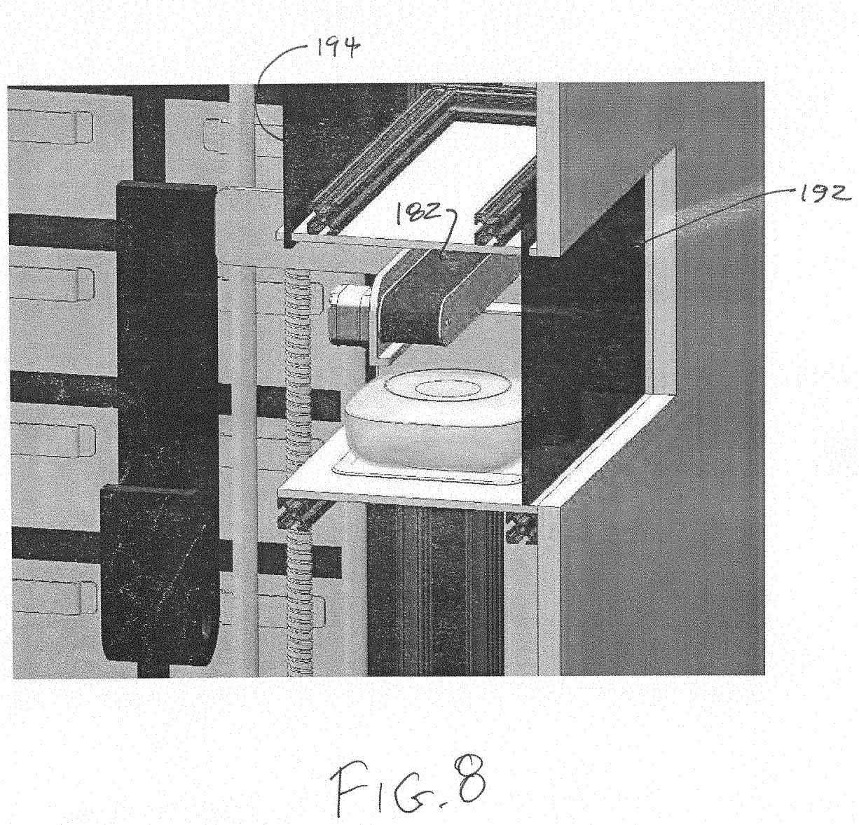

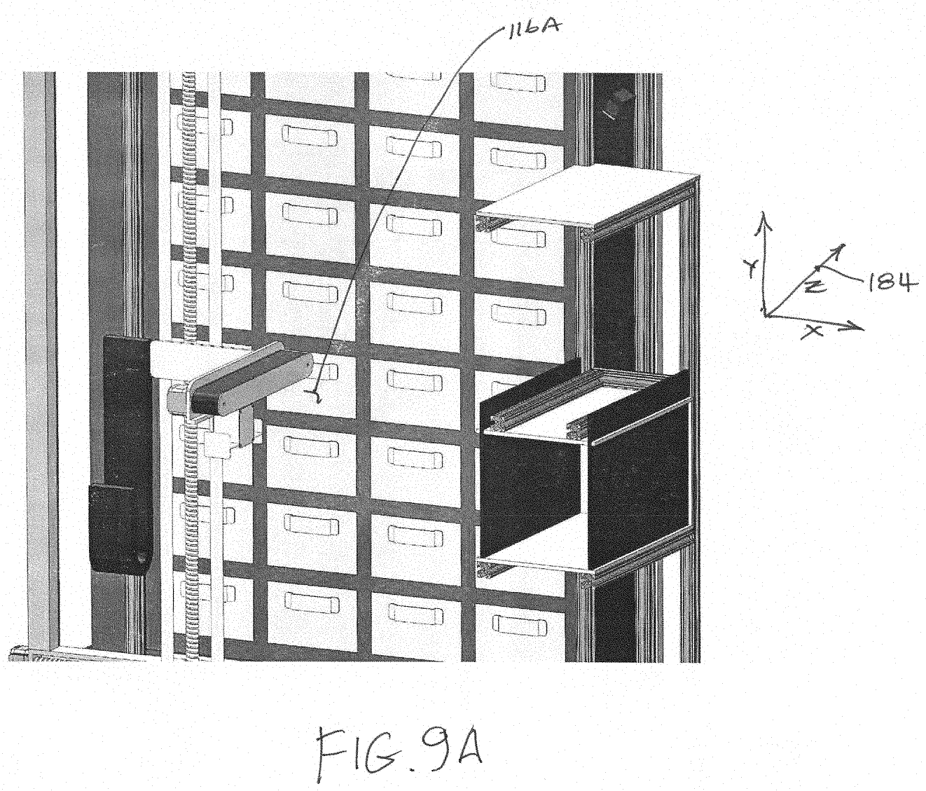

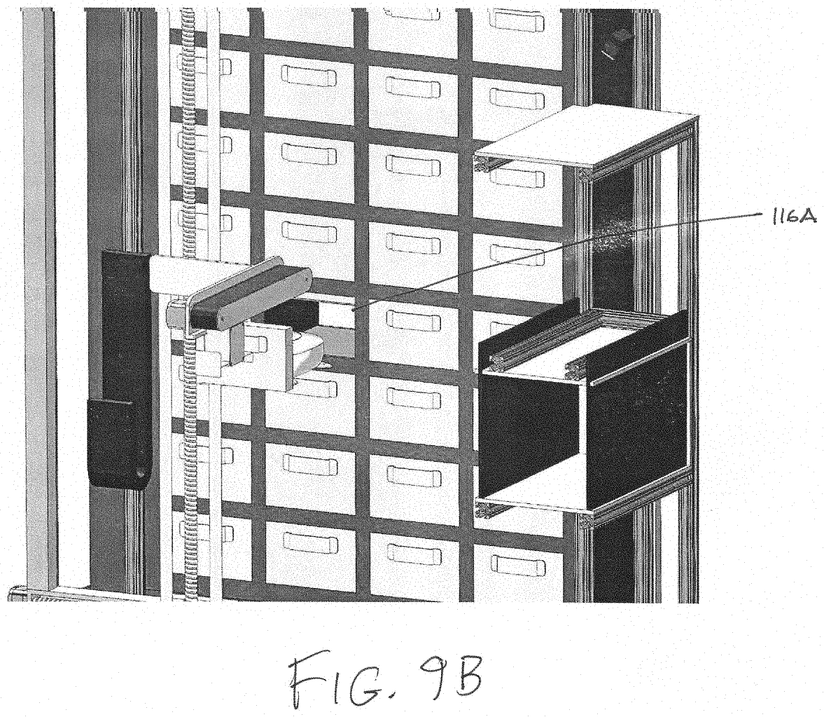

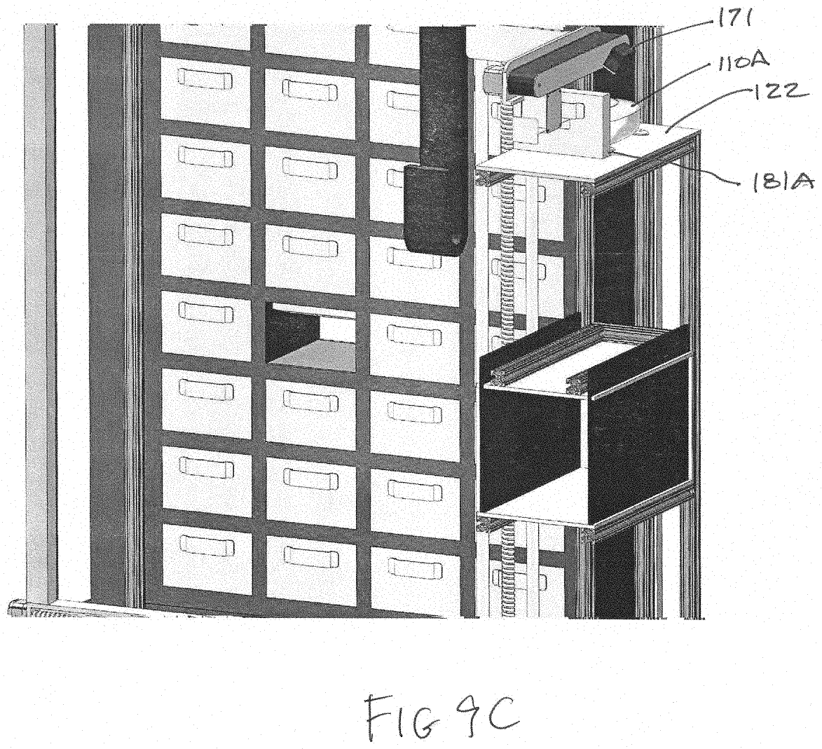

The Cartesian system includes a support-frame 176, the drive spindles, the stepper motors, and power and control cables. The End-Effector latches on to the Portion Container Carrier and delivers it to the Hatch. As shown in FIG. 7, the End-Effector is mounted on a Stepper Motor driven belt 182 for movement in the Z axis 184. The End-Effector includes two T-shaped brackets 186, one on the left and one on the right, for grabbing the Portion Container Carriers on the left and right sides respectively. Alternately the End-Effector may include a single T-shaped bracket that may swivel to the left or the right for grabbing portion container carriers on the left and right sides respectively.

Referring to FIG. 8, the Hatch include two shutters, Front Shutter 192 facing the Customer and Rear Shutter 194 at the back of the Hatch. These shutters are programmed to open and close during the delivery into the Hatch and the collection of the Portion Containers in order to help maintain a safe and sanitary condition within the station.

FIGS. 9A through 9L provide an incremental series which demonstrates the function of the Cartesian system in moving the End Effector from a selected Cubby 116A to the Scanner 171 (FIGS. 9A-9C), the return of the selected Portion Container Carrier 181A and Portion Container 110A from that Scanner and transport back to the Cubby (FIGS. 9D-9E), moving the Carrier and Container to the Hatch (FIGS. 9E-91), the delivery of that Portion Container to the Customer and reclosing of the Hatch (FIGS. 9J-9L).

The Transport System plays two major roles in the overall system:
1) Identifying the content and location of each Portion Container After the Portion Containers are randomly loaded into the Cubbies by the Deliver Partner the Food Station Control Logic commands the Transport System to initiate the data retrieval required for the entire operation of the system by scanning the labels of each Portion Container. To that end the Transport System will methodically pick up one Portion container after another, transport them to the scanning camera located within the transport space. The scanner scans the identifying label, unique to every Portion Container and stores that information in the Food Station Control Logic, including the identification of the specific Portion Container location within the station. The Transport System returns each Portion Container Carrier to its Cubby before repeating the process with the next Portion Container.
2) Delivering Portion Containers for Customer collection: When Customers identify themselves to the Station, the Food Station Control Logic communicates with the Transport System and directs the transport system to pick up the correct Portion Container and deliver it to the Hatch. When the Portion Container is removed from the Portion Container Carrier the Transport System returns the Portion Container Carrier to its cubby and waits for the next command from the Food Station Control Logic.

When the Customer comes back after eating (or when the customer comes to collect their next meal), the customer may bring the empty Portion Container back to the station. By inputting a “Return Container” command, the Hatch's Front Shutter opens, and the Customer is allowed to place the container into the Hatch. This may require no Customer Identification. The Front Shutter then closes, and the Rear Shutter opens, allowing the Transport System to either just move the contain to the Storage Area or to bring the container to the Scanner where its identification is noted for credit to the Customer. The Customer may be prompted to give feedback about the quality of his meal which may be used to adjust future menus in general or future offerings to this Customer.

There are four types of interaction between persons and the system;
1) The interaction with the customer when ordering the meal,
2) The interaction with the Delivery Partner when loading the filled Portion Containers into the Station,
3) The interaction with the Customer when collecting the meal,
4) The interaction with the Customer when returning he spent Portion Container, and
5) The interaction with the Delivery Partner when collecting the returned Portion Containers.

The Customer may select and order their meal in a variety of ways. In the preferable method an App is downloaded to the customer's Smartphone for the customer to register with the system. The App may have knowledge of or access to information about every Station everywhere and each Station's available menu at any given time. That App may have the ability to know and apply the Customer's location at any given time in order to offer access to only nearby Stations. That App may include a Customer Registry allowing the Customer to initially Sign-up and load relevant personal information, payment information, food type preferences, dietary restrictions and allergies, most common location of use (“home base”), etc. The Registered Customer may be assigned a Customer Number. That Customer Number may be used as the Customer's Identification Key. The Customer may also be required to select an Account Password for Identification.

Alternately, the Station may have a user interface allowing the Customer to input Customer Identification Information to gain access to the system, and to then make meal decisions for a later time directly with the Station. In this way the Customer could conveniently arrange the next day's order while picking-up today's meal. The Station could prompt the Customer such as “Would you like to place another order” or “10% off if you place another order within the next 15 minutes”, etc., thereby promoting additional sales before the customer has eaten today's meal and is presumably hunger.

Another communication option between Consumer and the System may be an Online Site accessible to the Customer, say from the convenience of their home or office. The Account could be set up similarly to the afore-mentions Smartphone App.

Alternately, the customer may be able to order meals via a call-in phone number.

The Delivery Partner arrives at the Station early on Day 0, unlocks Side Doors 196L and 196R of the Station and checks for unclaimed meals and returned empty Portion Containers, which are then removed and set aside. The Delivery Partner then loads the new Portion Containers, one per cubby, in no specific order or position. If the Storage Unit containing used portion containers is external of the Station, the Delivery Partner then visits the Storage Unit, and collects any used Portion Containers therein.

Customers approach the Station and identify themselves. Recognizing the Customer, the Food Station on-board Logic directs the transport system to pick up and deliver the Portion Containers into the Hatch. One Portion Container at a time.

The Food Station Control Logic recognizes when a Customer has not collected his meal by some period after the pre-designated pick-up time, then sends a reminder, such as by text or notice to the Customer's Smartphone, or by email or by phone call. Based on feedback which may then be provided by the Customer, the logic system may; keep food at heated temperature for an additional specified time, chill the food to avoid spoilage and reheat based on feedback from Customer, or chill the Portion Container and inform food Delivery partner to remove un-claimed Portion Containers during the following morning visit.

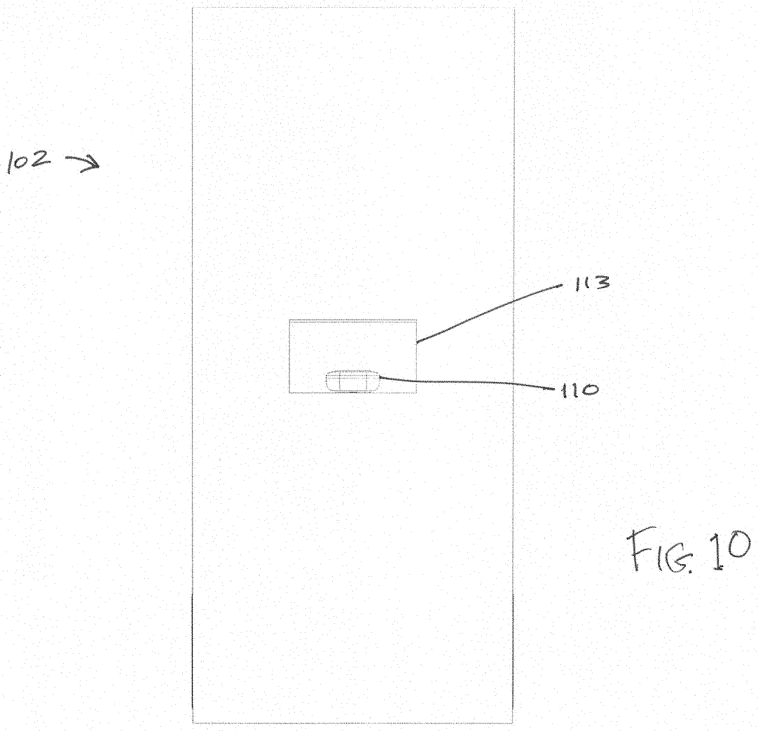

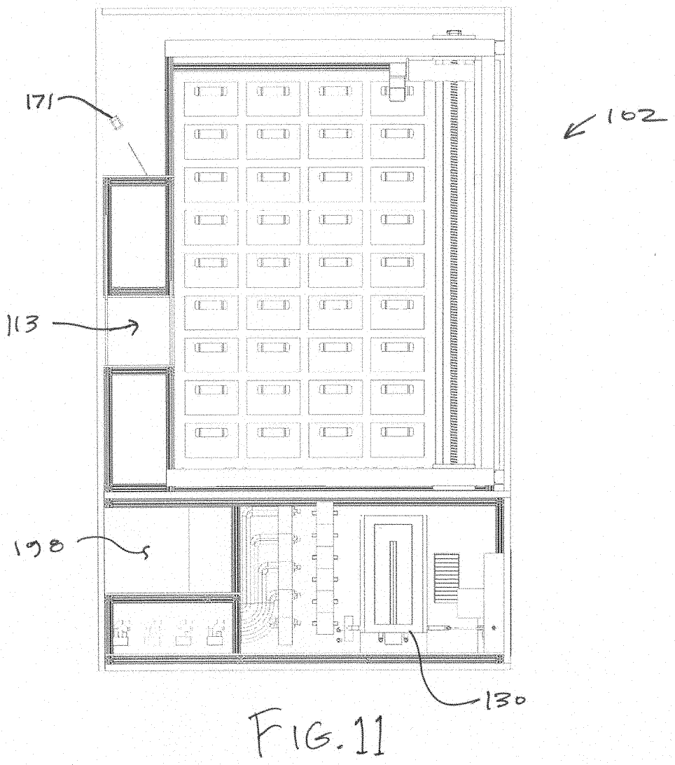

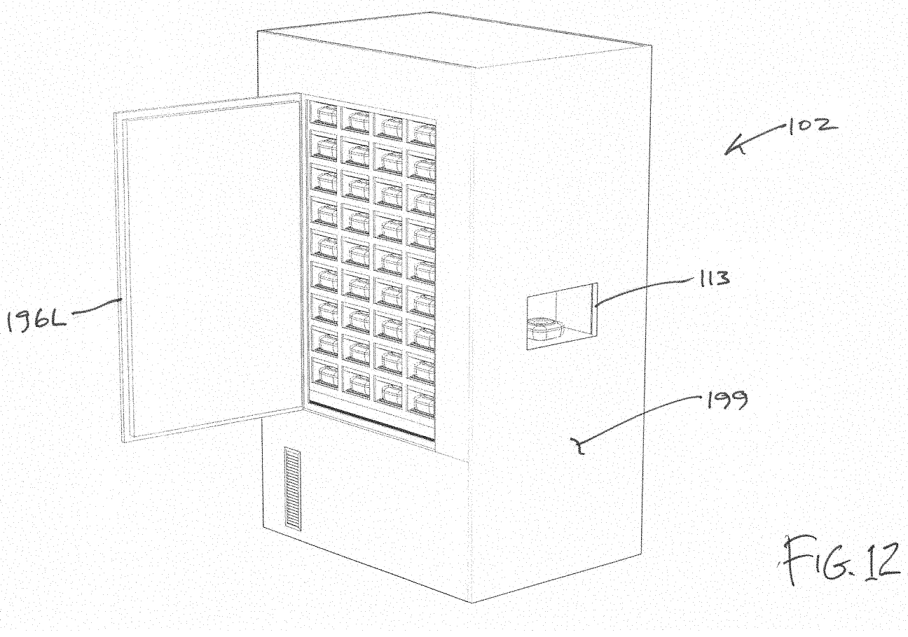

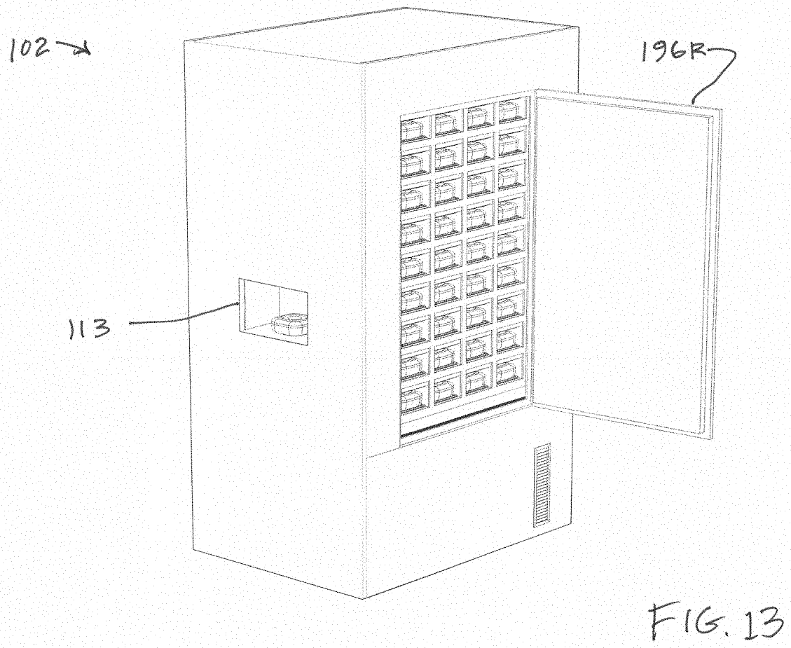

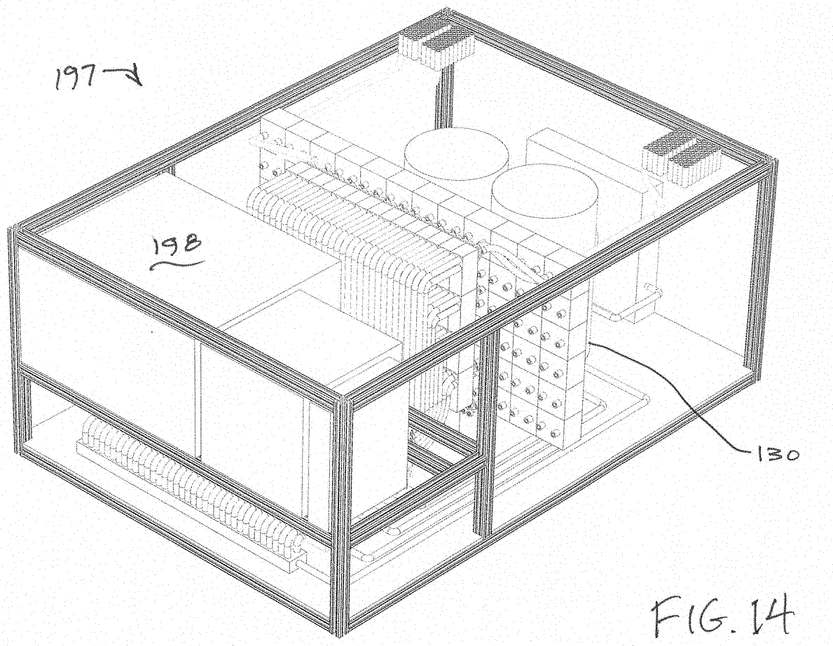

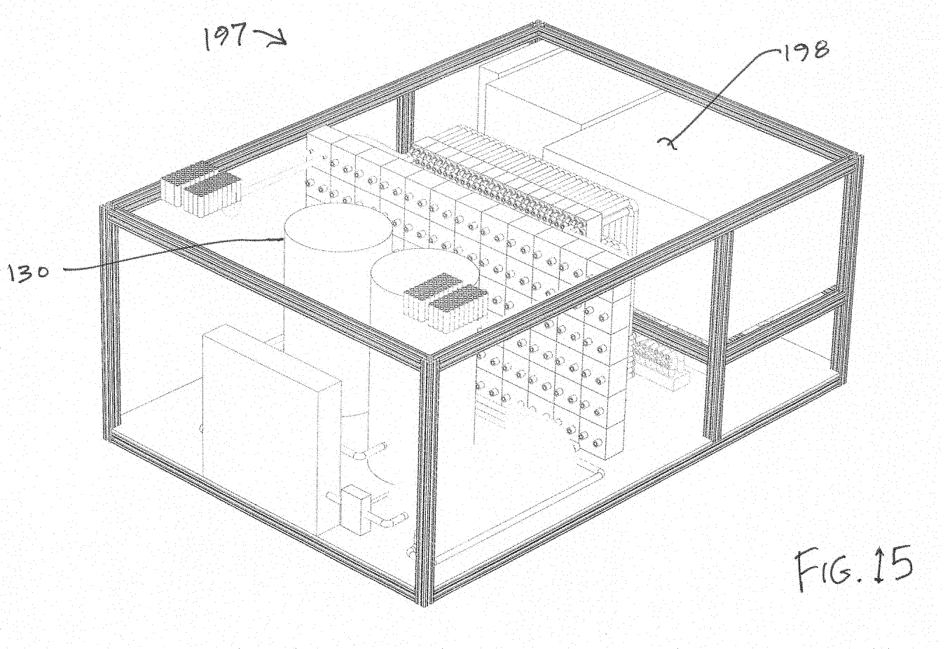

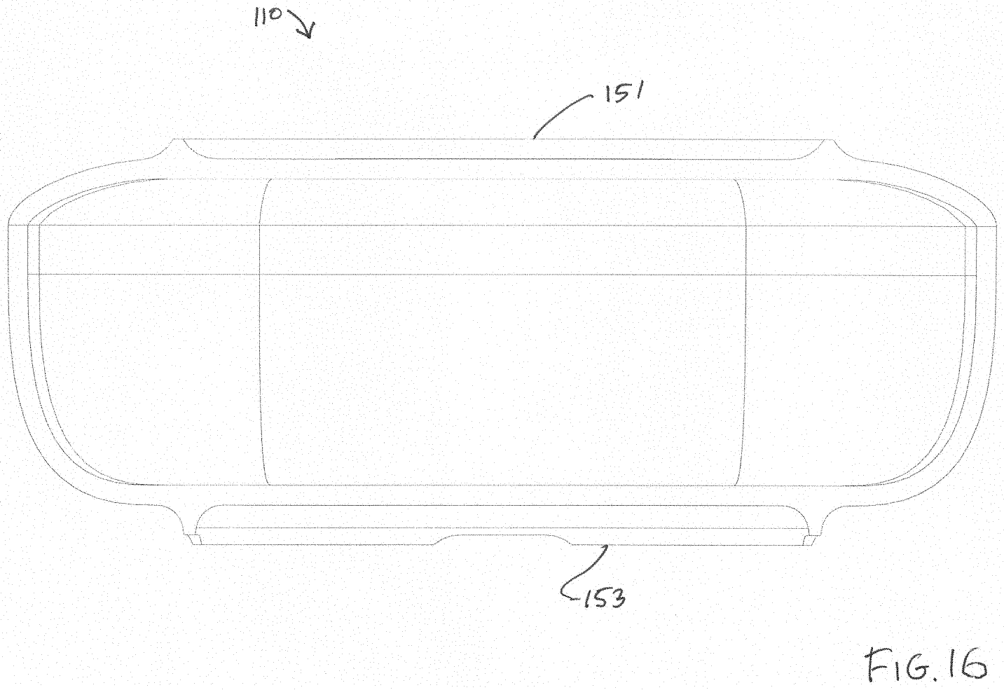

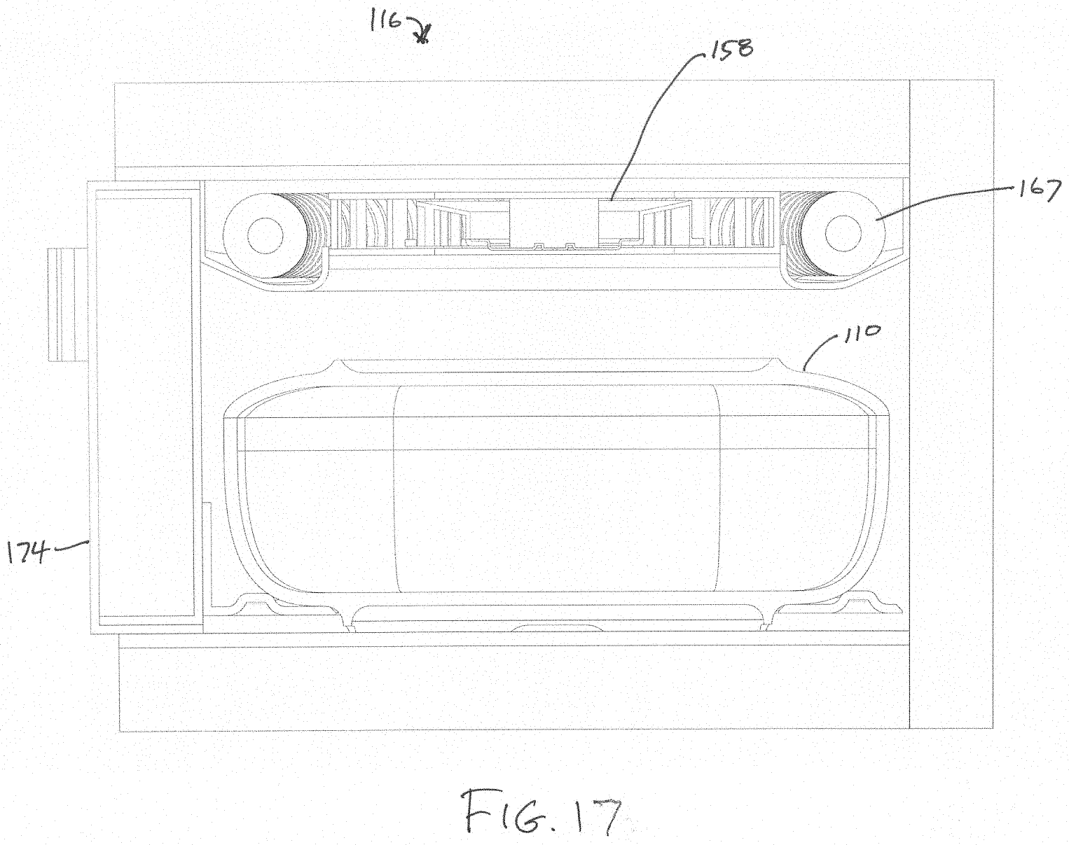

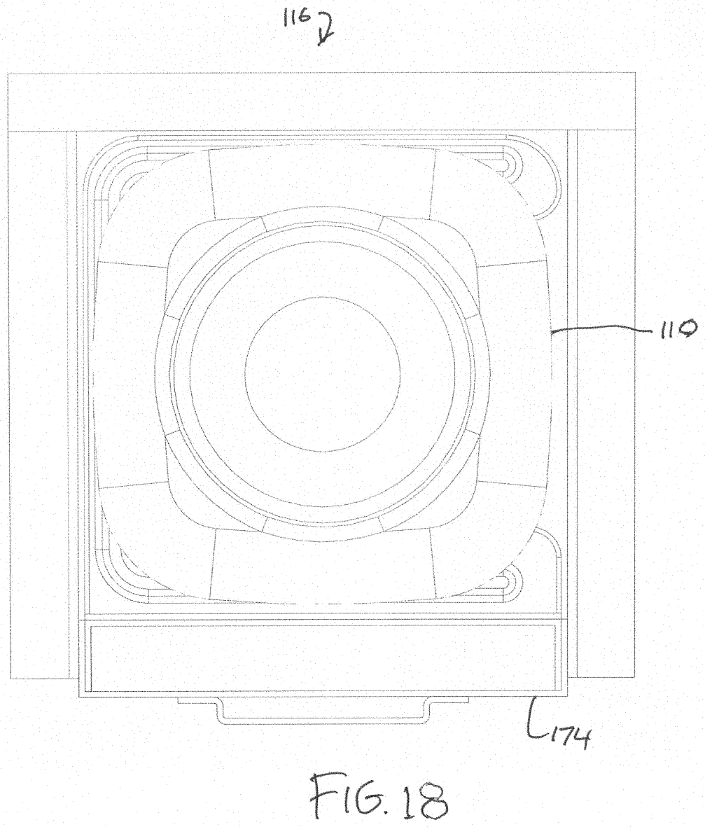

Referring to FIGS. 10 and 11, the 49″ width and 72″ height of the Station allow it to be moved through a standard commercial door, with an opening of 36″ wide and 80″ tall. The Station includes 72 Cubbies, and the Hatch is positioned approximately halfway up the Station's height for most-convenient customer access (See FIGS. 10 and 11). Referring to FIGS. 12 and 13, the Left and Right Side Panels (Delivery Partner Access Doors) 196L and 196R are large to ease loading, provide visibility of all Cubbies, enable cleaning, and are insulated as they serve as the outside wall of the Cubbies. They allow quick and easy access to the Delivery partner to place the Portion Containers into the Cubbies and to do other internal tasks.

Referring to FIGS. 14 and 15, the lower portion 197 of the Station is dedicated to house the cooling and heating system and various controls. It also houses the System Computer 198 and provides for the structural integrity of the entire unit, including the Transport System and the Cubbies. The Station walls 199 include adequate thermal and acoustic insulation and are structurally designed to carry the weight of the rest of the system.

To more efficiently utilize the space within the cubic-shaped Station, the Cubbies have a cubic outer shape.

Referring to FIG. 16, the Portion Containers have a round shape which, being similar to most dishware, is familiar to Customers as a food serving device. When separated, the lids 151 of the containers are easily stackable and the bases 153 of the containers are easily and compactly nestable.

Referring to FIGS. 17, 18, and 20, it can be appreciated that air circulation is improved for heating and cooling of the Portion Containers within the Cubbies because the cubbies have a cubic inner chamber, and the portion containers have a rounded shape.

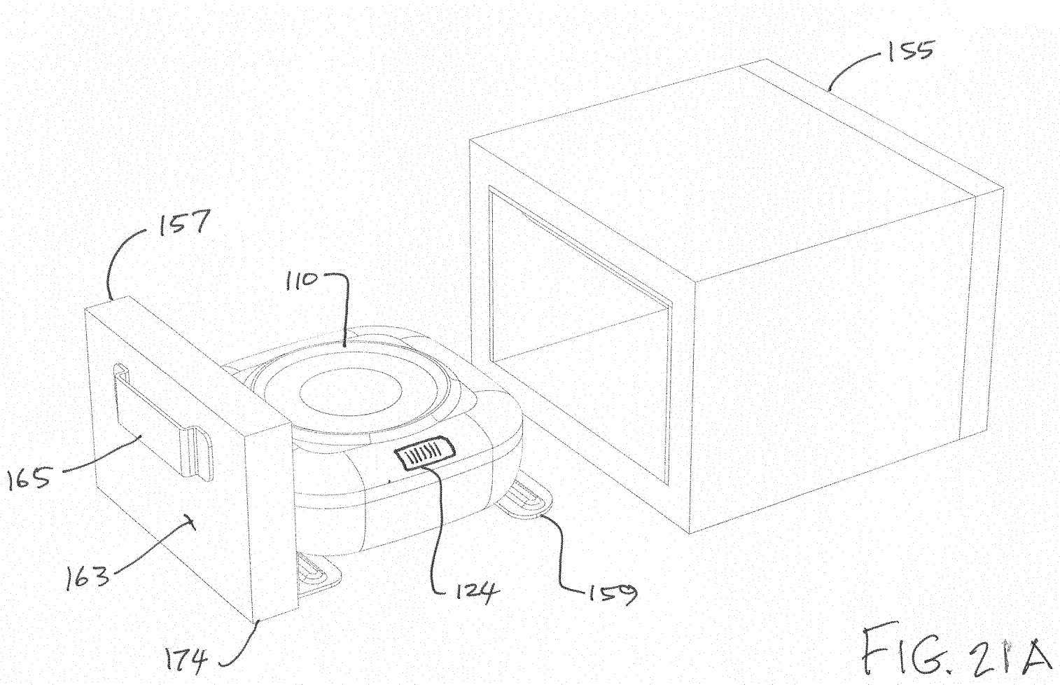

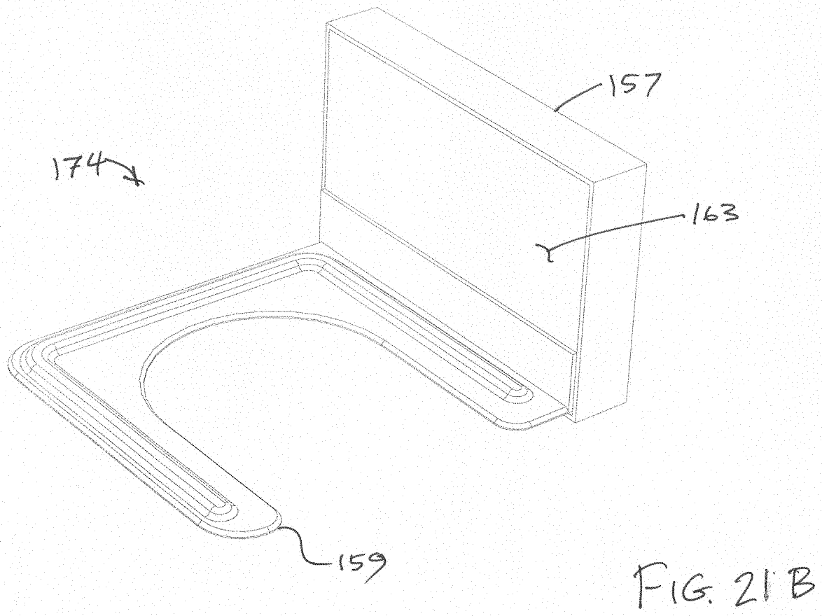

Referring to FIG. 21A, the Cubbies are insulated to save energy and facilitate easy loading and removal of the Portion Containers. The Cubbies include enough internal space for the Portion Container a Heat Transfer Element 167 and insulation on all four sides. The back 155 of each Cubby is open but is covered by the Station Wall.

Referring to FIGS. 21A and 21B, the front 157 of each Cubby is part of the Portion Container Carrier comprising an insulated wall, connected to a horseshoe shaped horizontal metal plate 159 designed to support the Portion Container. The Portion Container Carrier serves to support the Portion Containers as it is transported by the transport system from the cubby to the hatch to be collected by the Customer, or to the scanning camera during the identification routine.

The Station logic system may include features allowing the customization of temperature of each Portion Container that may be based on Customer selection and/or its contents.

The Portion Container Carrier supports the Portion Container while in its Cubby, for better air circulation, and while being transported by the Transport System. The Carrier consists of two basic elements: the horseshoe-shaped support plate which is permanently fixed to the removable front panel of the cubby, including a 1″ thick insulated block 163. The insulated front features a handle portion 165 that is adapted to be grasped by the End-Effector of the cartesian transport system. The horse-shoe shape is Designed and shaped to slide out from under the Portion Container lower rim to be left in the Hatch while the Carrier is being withdrawn.

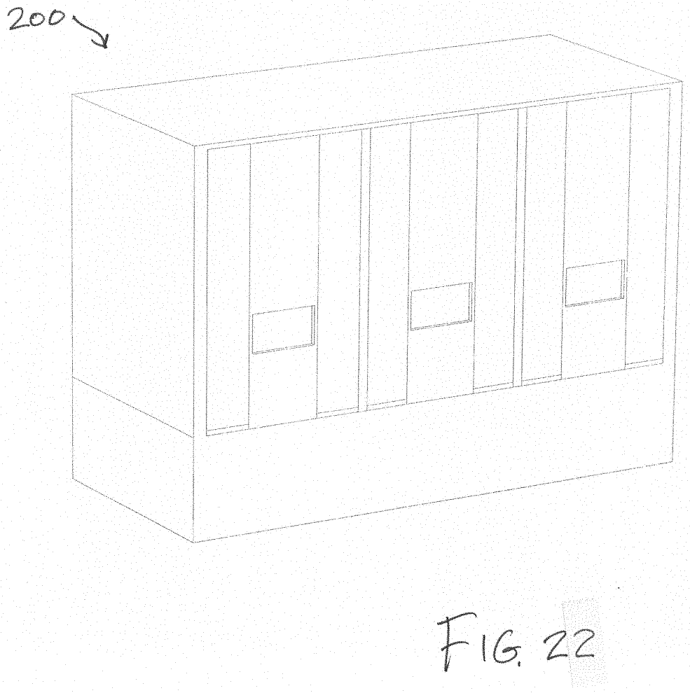

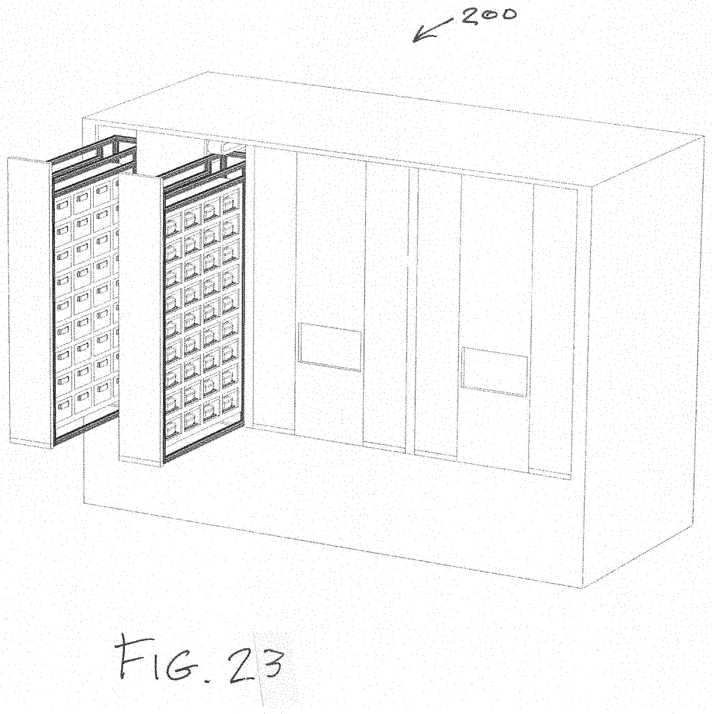

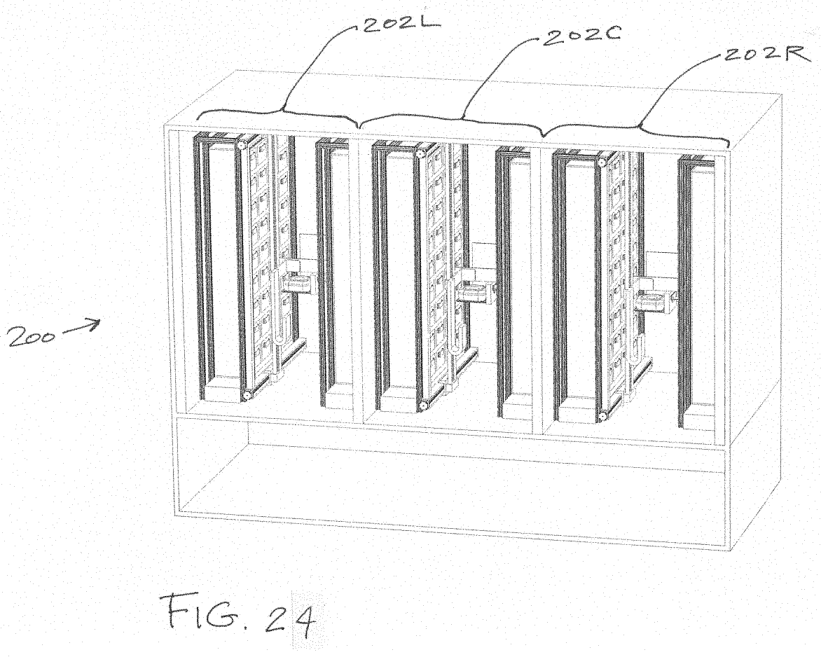

A second Station 200 constructed of multiple Modules 202L, 202C and 202R, and intended to serve a larger number of Customers is shown in FIGS. 22-24. The basic operational concept of each module remains the same as the first embodiment except that additional modules are added, each including its own Cubbies, Hatch, Transport System, and End Effector. All modules are connected to a single Control Logic. The alternate front-loading of the modules enables a compact manner for the Delivery Partner to service the Station. A virtually unlimited expansion is enabled by the simple addition of Modules in side-by-side fashion. The Customer arriving to collect the food is directed to the specific one of the Hatches where the portion containers may be collected.

This expanded version allows the Food Partner to prepare additional un-ordered meals, snacks, desserts, side dishes, etc., to be deposited into the Station for spontaneous purchasers. Thereby being able to accommodate Customers who did not order in advance or who find themselves hungrier than originally expected. The Station could prompt the customer to add to their pre ordered purchase . . . “Would you like fries with that?” . . . “Would you like to add a dessert?”. Such items may carry a premium cost, due to the risk the Food Partner takes and to encourage Customers to order in advance.

This expanded Station could be further expanded by the addition of Modules according to the traffic expected in the area it is to be placed. It could be installed in private or public locations, such as airport terminals or train stations, where people could pick up a pre ordered meal before boarding. Ballparks, beaches, campgrounds, and other recreational venues are perfect candidates for setting up such a Station. High-end restaurants could set up dedicated Stations at airports or other public places, such as downtowns and business centers.

It should be understood that while the invention has been shown and described with reference to the specific exemplary embodiments shown, various changes in form and detail may be made without departing from the spirit and scope of the invention, and that the invention should therefore only be limited according to the following claims, including all equivalent interpretation to which they are entitled.

We claim:

1. A system including software and an apparatus for enabling a consumer to choose, order, and pay for a chosen consumable, from a menu of numerous consumables, remotely from the apparatus, and to be delivered the chosen consumable in a fresh and properly temperatured state by the apparatus at a chosen future time.

2. The system of claim 1 further adapted to provide the consumer with a security key for enabling identity verification at the apparatus wherein the consumer becomes an identified consumer.

3. The system of claim 2 wherein the apparatus comprises a chamber for receiving and storing the chosen consumable and is adapted to cool the chamber to maintain freshness of the chosen consumable during the storage and until an appropriate time prior to the chosen future time, and to heat the chamber at the appropriate time to cause the properly temperature state upon the delivery.

4. The system of claim 3 wherein the apparatus begins heating the chamber at the appropriate time according to predetermined preparation instructions specific to the chosen consumable to obtain the properly temperature state, and moves the properly temperatures consumable to a delivery port of the apparatus upon demand by the identified consumer.

5. The system of claim 4 adapted to allow the consumer, prior to the appropriate time, to amend the chosen future time to a later time.

6. The system of claim 5 wherein the apparatus comprises a transport mechanism for moving the chosen consumable from its associated chamber to the delivery port upon the demand, at or around the chosen future time or the later time.

7. The system of claim 6 wherein the apparatus further comprises a scanner adapted to obtain a consumable identification from the chosen consumable.

8. The system of claim 6 wherein the software further comprises apparatus logic adapted to link the order, the chosen future or later time, the appropriate time, the preparation instructions, and the associated chamber with the consumable identification.

9. The system of claim 8 wherein the logic causes the transport mechanism to move the chosen consumable from its associated chamber upon deposit therein to the scanner for the consumable identification, then to return the identified chosen consumable to the associated chamber, then to affect the preparation instructions at the associated chamber at the appropriate time, then to move the chosen consumable to the delivery port at the demand, and then to allow access to the delivery port by the identified consumer.

11. The system of 10 wherein the software includes a smartphone app.

12. The system of claim 11 wherein the smartphone app is adapted to enable consumer registration and consumer payment.

13. The system of claim 12 where the consumer registration includes assignment of a registration number and a password, and wherein one or both of the registration number and password are the security key.

14. The system of claim 13 wherein the software allows the amendment of the chosen future time to the later time only by the identified consumer. A15. The system of claim 14 wherein the apparatus comprises a plurality of chambers for association with a plurality of chosen consumables ordered by a plurality of consumers.

16. The system of 10 wherein the software includes an interactive website.

17. The system of claim 16 wherein the interactive website is adapted to enable consumer registration and consumer payment.

18. The system of claim 17 where the consumer registration includes assignment of a registration number and a password, and wherein one or both of the registration number and password are the security key.

19. The system of claim 18 wherein the software allows the amendment of the chosen future time to the later time only by the identified consumer.

20. The system of claim 19 wherein the apparatus comprises a plurality of chambers for association with a plurality of chosen consumables ordered by a plurality of consumers.
